(19) United States
(12) Patent Application Publication
(10) Pub. No.: US 2012/0279371 A1
(43) Pub. Date: Nov. 8, 2012

(54) Meat cubing and skewering device

(76) Inventors: Charles Lee Mulchi, JR., Silver Spring, MD (US); Nick Pete Lemberos, Silver Spring, MD (US)

(21) Appl. No.: 13/100,262

(22) Filed: May 3, 2011

(51) Int. Cl. A22C 17/00; B26D 3/18

(52) U.S. Cl. 83/821

(57) ABSTRACT

This meat cubing and skewering device utilizes a low friction guide system along two axes to facilitate the cutting of meat slabs into cubes for the purpose of making shish kebobs or Souvlaki. The device also provides for a means of skewering the cubes using an array of dimpled apertures in equivalent top and bottom plates that minimizes the multiple skewer interference that can occur at the bottom of such devices. The four vertical sides are made up of a series of paired elongated rods or rollers that serve as cutting guides and these four vertical sides are hinged in such a way as to keep them all together and yet fold flat for easy storage and cleaning within a dishwasher.

### BACKGROUND OF THE INVENTION

1. Field of the Invention

The invention relates generally to the quick and efficient cutting of meat into cubes and the subsequent placement of these cubes onto kebobs and/or skewers.

2. Description of the Prior Art

There are a few meat cutting devices in the prior art, on a non-industrial scale, that facilitate the cubing of meat and subsequently placing the cubes onto kebobs. Most relevant to the present invention is the Panaritis patent from 1977, U.S. Pat. No. 4,056,026. It discloses a device which guides the cutting of meat with a handheld knife along two axes. Thus, if meat placed within the device is already cut into roughly equal slabs and these slabs are laid upon their side one on top of the other, the device can create meat cubes via two equal and vertical series of cuts at a 90° angle from each other. Furthermore, apertures placed at the top of the device can be utilized for the placement of kebobs that will skewer all the meat cubes within a local vertical axis. Other relevant handheld knife cutting guides include: U.S. Pat. No. 3,817,138, U.S. Pat. No. 3,452,795, U.S. Pat. No. 2,679,274 and U.S. Pat. No. 2,398,192. In addition, there is one industrial scale meat cubing device, U.S. Pat. No. 5,161,447 that employs multiple slits for guiding the cutting of meat.

The prior art exhibits several limitations: (1) the guides permit for only one or two cutting axes provided the food item is not manually rearranged; (2) using simple slits within otherwise solid planes, particularly while cutting meat of uneven consistency, can create significant friction between the cutting knife and the sides of the slit; (3) the use of thin slits impair the cutter's ability to see the food item and exactly where the cutter has already made cuts; and (4) the prior art does not demonstrate a means by which a meat cubing device can be quickly and easily broken down so as not to occupy valuable kitchen space.

### SUMMARY OF THE INVENTION

The present invention provides an efficient means of guiding the cutting of meat into cubes and then placing these cubes onto kebobs or skewers. Additionally, the design provides for easy cleaning and low volume storage of the device.

The device is composed of six sides which when fastened together form a generally cubical shape. The top side possesses apertures through which kebobs or skewers can be inserted. The four vertical sides are comprised of a series of mounted elongated rods or rollers that incorporate flexible bearing materials to allow for a wide range of cutting instrument spine thickness. The rods or rollers are spaced in such a way as to form an obvious pairing in which each roller is spaced very closely to one additional roller. This narrow spacing between any given pair of rollers serves as an auto-aligning cutting guide for a handheld knife. The larger gap between roller pairs allows the user to see what they are doing, view the movement and condition of the item they are cutting, and keep track of where they have already cut. The use of rollers also reduces cutting friction, minimizes the chance of damage to the roller surfaces caused by serrated cutting knives, and also prevents shedding of guide roller surfaces due to rotational motion and tangential contact with the cutting knife.

The four vertical sides are hinged together so as to permit a 0° to 180° range of movement. This enables the four vertical sides, when decoupled from the top and bottom sides, to be flattened into a plane. This plane would be composed of two layers abutting one another and each layer would be composed of two sides. The quick coupling and decoupling of the vertical sides to the top and bottom sides is accomplished through the use of locking guide pins. Finally, if it is necessary to prevent the lateral motion of the meat during the placement action, there is a divider mechanism that can be inserted in between the rollers pairs of any given cutting guide pair and this plane like mechanism is long enough to be inserted into the analogous cutting guide pair on the opposite side thus permitting a solid anchoring for the divider. The divider incorporates internal slits which permits smaller quantities of food materials to be prepared using only a portion of the internal storage area. Finally, the divider allows for the simultaneous preparation of Kebobs containing multiple types of food materials during the same loading/cutting sequence.

### BRIEF DESCRIPTION OF THE DRAWINGS

An embodiment of the present invention will now be described by way of an example and with reference to the accompanying drawings, in which:

FIG. 1 illustrates all the major parts of the meat cutting device using an elevated view.

FIG. 2 illustrates the divider mechanism and where it can be inserted with respect to the rest of the device.

FIG. 3 illustrates the equivalent top and bottom views of the device.

FIG. 4 illustrates the equivalent top and bottom views of the four vertical sides with the top and bottom plates removed.

FIG. 5 illustrates the equivalent top and bottom views of the four vertical sides in a folded flat position.

FIG. 6 illustrates the interior design details of the cutting guide.

FIG. 7 illustrates the exterior design details of the cutting guide.

### DETAILED DESCRIPTION

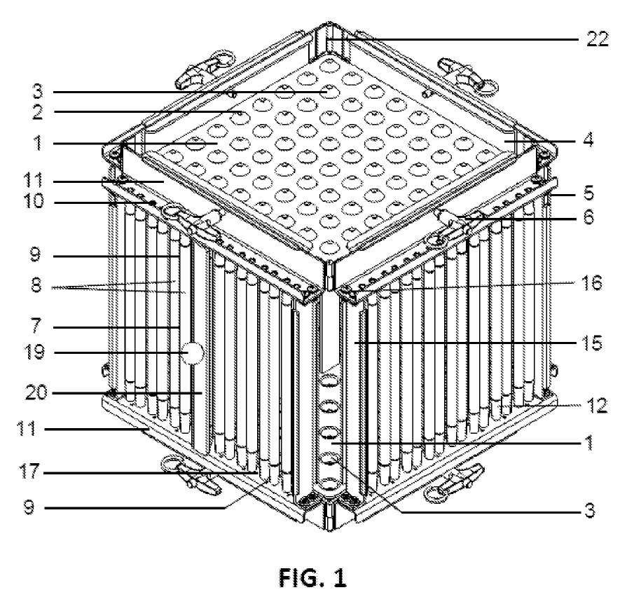

An elevated view of the meat cutting device, as shown in FIG. 1, illustrates all of its major parts. The identical top and bottom plates 1 are made up of an array of evenly spaced apertures 2 that are set off from the inter-aperture plane by a series of conically shaped dimples 3 that surround the apertures 2. The apertures 2 are set above the inter-aperture plane at the top and set below at the bottom. The purpose of the apertures 2 is to permit the insertion of skewers for the making of shish kebobs or Souvlaki. On the bottom plate, the conically shaped dimple 3 surrounding each aperture 2 assists in guiding a skewer head through the relatively narrow aperture. By better controlling the alignment of skewer heads along the bottom, there is less probability of skewer interference with one another and thus less probability of multiple-skewered or non-skewered meat cubes near the bottom of the device. The top and bottom plates 1 also have four vertical walls 4 on their sides. These serve to interface with the four vertical sides of the device 5 and to provide a hole through which a locking guide pin 6 connects the top and bottom plates with the four vertical sides 5. In addition, these plate walls 4 also possess a shelf like projection that simplifies lifting the top and bottom plates 1.

Each of the four vertical sides 5 are comprised of a series of cutting guides 7. Each cutting guide 7 is a pair of closely spaced rods or rollers 8. The space 9 in between these rods or rollers 8 guides the cutting action and the use of elongated rollers is preferred as they minimize friction during the cutting action of a handheld blade. The rods or rollers 8 are mounted in place with guide pins 10 that are anchored within upper and lower brackets 11. The rods or rollers 8 are tapered 12 at the ends so as to permit the insertion of large knife blades where the rods or rollers 8 are at their stiffest. The ends of each roller also incorporate a flexible bearing 13 that allows for a wider range of spine thickness for cutting instruments as well as a polytetrafluoroethylene (PTFE) sleeve bearing 14 that further reduces rotational friction. The upper and lower brackets 11 are held firmly together at the ends with metallic strips 15 that are mounted to the brackets with screws 16. The cutting guides 7 are spaced sufficiently apart 17 so as to allow the cutter to visualize both the food item being cut and the cutting itself. By creating more spacing between the cutting guides rather than between the rods or rollers 8 that make up the cutting guide itself 7, it is easier for the cutter to keep track of where they have already cut.

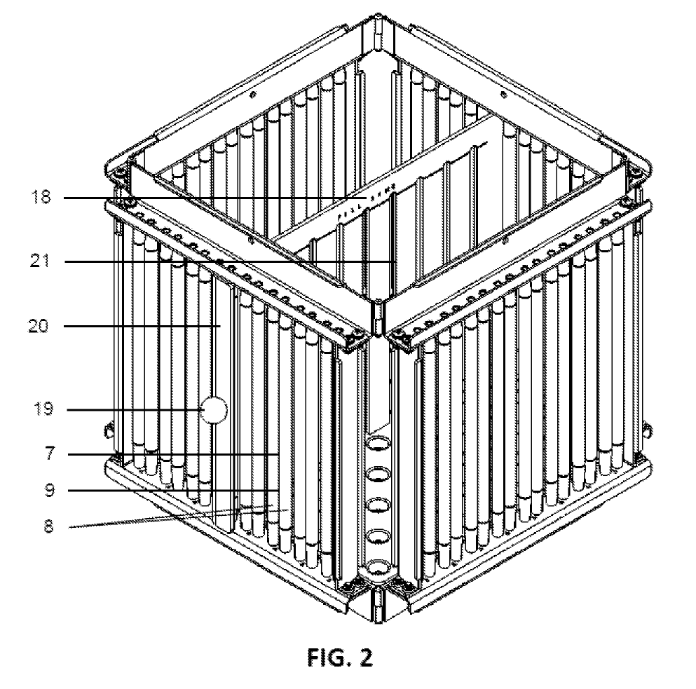

FIG. 2 illustrates how the divider mechanism 18 is inserted into the device between the rods or rollers 8 of any given cutting guide 7. The divider 18 limits the lateral motion of food items that are significantly smaller than the device itself and also permits the simultaneous preparation of kebobs using multiple food materials. The divider 18 possesses the necessary dimensions to fit through the small space 9 between the rods or rollers 8 of each cutting guide 7 and made long enough to reach between and through the analogous space 9 of the analogous cutting guide 7 on the opposite side of the device. The cutter manipulates the divider with the use of a handle 19 and this handle is mounted to the divider 18 via a shelf like projection 20 at the handle end of the divider 18. The divider 18 also incorporates multiple slits 21 which permit the guided cutting of partial loads of food materials or simultaneous cutting of multiple food items. It is possible to employ the cutting guide 7 system of the device's four vertical sides 5 to define the divider slits 21. However, due to strict size limitations and the requisite complexity attending an auxiliary item, it is preferable to use simple slits and these slits should be rounded to minimize friction.

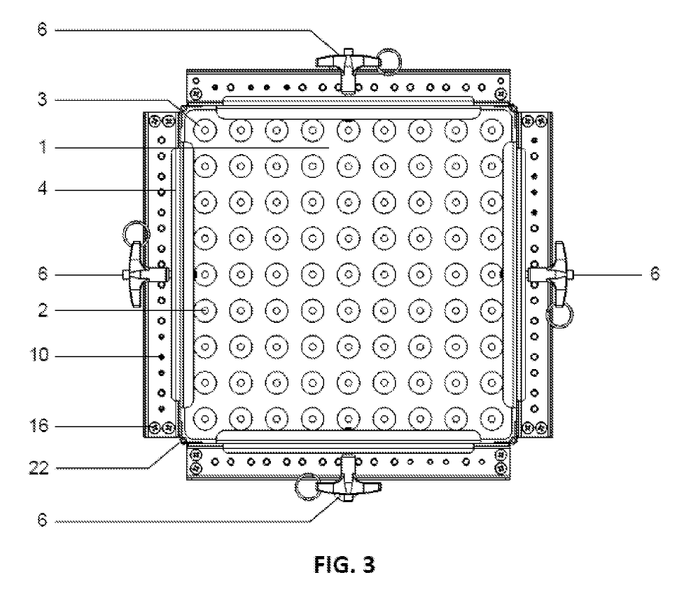

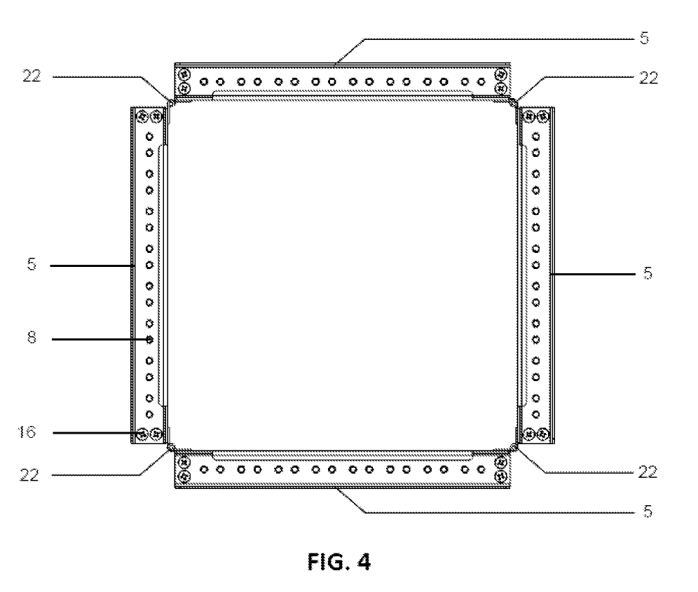

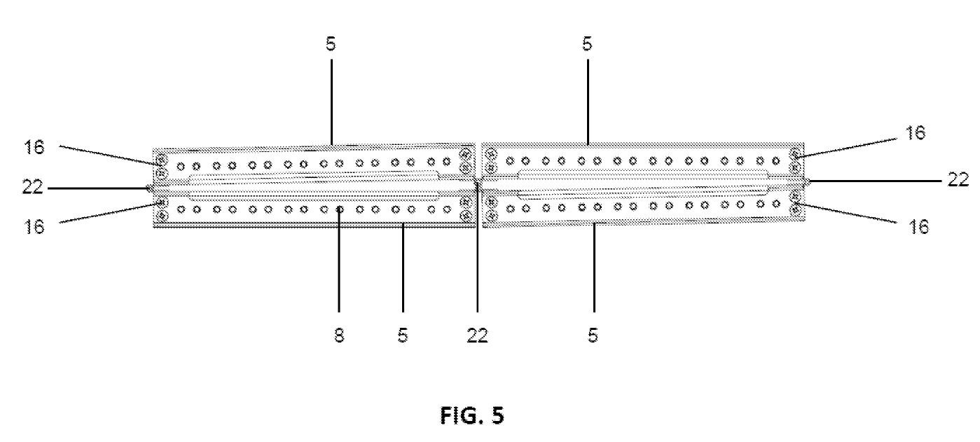

FIG. 3 illustrates the equivalent top and bottom views of the device fully in tact. FIG. 4 illustrates the equivalent top and bottom views of the four vertical sides 5 at 90 degree angles from one another and without the top or bottom plates. Both FIG. 3 and FIG. 4 show the hinges 22 that bind the four vertical sides 5. FIG. 5 illustrates how the four vertical sides 5 attached with hinges 22 permitting 0 to 180 degree rotations and decoupled from the top and bottom plates 1 can readily fold into a flat configuration for improved storage and cleaning inside a dishwasher.

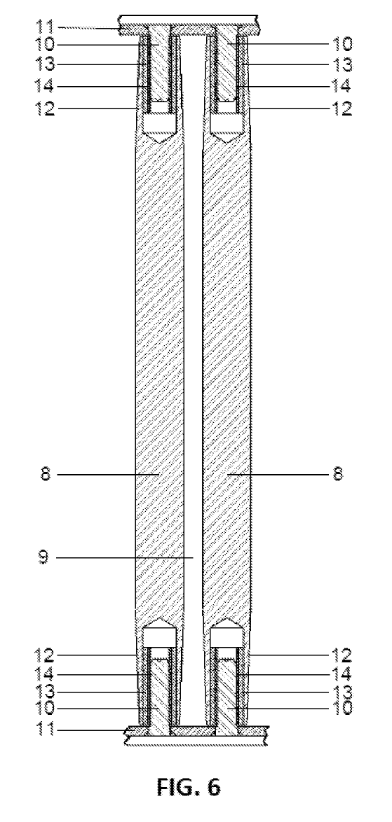

FIG. 6 illustrates the interior cutaway view of a cutting guide 7 which incorporates a pair of rollers 8 that each contain a pair of flexible bearings 13 that allow the device to accept a wider range of spine thickness for cutting instruments inserted into cutting slit 9 as well as a pair of Polytetrafluoroethylene (PTFE) sleeve bearings 14 to further reduce rolling resistance. The rollers 8 are suspended between two guide pins 10 that are anchored within upper and lower brackets 11.

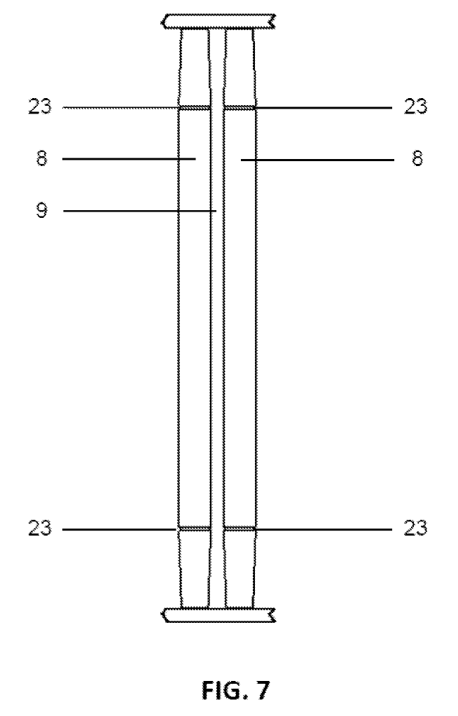

FIG. 7 illustrates the exterior view of the cutting guide 7. The rods or rollers 8 contain a prominent sight ring 23 that is either painted or etched on to the ends of each rod or roller to indicate recommended fill levels when loading food materials for cutting.

I claim:

1. A meat cutting device possessing generally cubical dimensions that is intended to facilitate the preparation of meat cubes and the placement of said meat cubes onto skewers or kebobs on a small scale kitchen-like setting comprising:
four vertical sides forming a generally rectangular or square shape surrounding the meet item to be cut with opposite sides being substantially identical to one another; and
each of said four sides possessing a series of paired elongated cutting guides consisting of rods or rollers and a small gap in between said rods or rollers to enable the insertion and cutting action of a handheld knife.

2. A meat cutting device possessing generally cubical dimensions that is intended to facilitate the preparation of meat cubes and the placement of said meat cubes onto skewers or kebobs on a small scale kitchen-like setting comprising:
four vertical sides forming a generally rectangular or square shape surrounding the meet item to be cut with opposite sides being substantially identical to one another;
each of said four sides possessing a series of paired elongated cutting guides consisting of rods or rollers and a small gap in between said rods or rollers to enable the insertion and cutting action of a handheld knife; and
a substantially planar divider mechanism possessing dimensions that enable it to slide in between the any cutting guide pair and possessing sufficient length so that it may slide in between cutting guides on the opposite side of the cutting device.

3. A meat cutting device possessing generally cubical dimensions that is intended to facilitate the preparation of meat cubes and the placement of said meat cubes onto skewers or kebobs on a small scale kitchen-like setting comprising:
four vertical sides forming a generally rectangular or square shape surrounding the meet item to be cut with opposite sides being substantially identical to one another;
each of said four sides possessing a series of paired elongated cutting guides consisting of rods or rollers and a small gap in between said rods or rollers to enable the insertion and cutting action of a handheld knife;
a substantially planar divider mechanism possessing dimensions that enable it to slide in between any cutting guide pair and possessing sufficient length so that it may slide in between cutting guides on the opposite side of the cutting device; and
a folding mechanism that enables said four sides to remain held together and yet collapse into a flattened state that is no thicker than width of two sides by making the said four sides possess identical dimensions and through the use of hinges possessing an angle of rotation that is at least 0 to 180 degrees.

4. A meat cutting device as in claim 1 wherein the cutting guide is comprised of rods or rollers that are tapered at the top and bottom to create a wider gap between the rod or roller pair at the top and bottom.

5. A meat cutting device as in claim 1 wherein there is a substantial gap of at least 0.5 cm between each cutting guide.

6. A meat cutting device as in claim 1 wherein the four vertical sides are held in a substantially 90 degree angle with one another by mating with top and bottom plates and this mating is made rigid through use of a lock pin that inserts though corresponding holes at the top and bottom of the four vertical sides and the four sides of the top and bottom plates.

7. A meat cutting device as in claim 1 wherein the top and bottom plates are substantially identical and possess an evenly spaced array of apertures with said apertures existing on a different plane than the inter-aperture part of said plates and each said aperture is supported via a dimpling in the plate that possesses a substantially conical shape.

8. A meat cutting device as in claim 1 wherein the cutting guide consists of elongated roller pairs and said rollers are held in their vertical position through the use of guide pins inserted into the hollowed out ends of the elongated rollers and the friction between the roller and guide pin is minimized through the use of a Teflon sleeve surrounding the guide pin and an elastic substance mounted to the top of the guide pin.

9. A meat cutting device as in claim 2 wherein the cutting guide is comprised of rods or rollers that are tapered at the top and bottom to create a wider gap between the rod or roller pair at the top and bottom.

10. A meat cutting device as in claim 2 wherein there is a substantial gap of at least 0.5 cm between each cutting guide.

11. A meat cutting device as in claim 2 wherein the four vertical sides are held in a substantially 90 degree angle with one another by mating with top and bottom plates and this mating is made rigid through use of a lock pin that inserts though corresponding holes at the top and bottom of the four vertical sides and the four sides of the top and bottom plates.

12. A meat cutting device as in claim 2 wherein the top and bottom plates are substantially identical and possess an evenly spaced array of apertures with said apertures existing on a different plane than the inter-aperture part of said plates and each said aperture is supported via a dimpling in the plate that possesses a substantially conical shape.

13. A meat cutting device as in claim 2 wherein the cutting guide consists of elongated roller pairs and said rollers are held in their vertical position through the use of guide pins inserted into the hollowed out ends of the elongated rollers and the friction between the roller and guide pin is minimized through the use of a Teflon sleeve surrounding the guide pin and an elastic substance mounted to the top of the guide pin.

14. A meat cutting device as in claim 3 wherein the cutting guide is comprised of rods or rollers that are tapered at the top and bottom to create a wider gap between the rod or roller pair at the top and bottom.

15. A meat cutting device as in claim 3 wherein there is a substantial gap of at least 0.5 cm between each cutting guide.

16. A meat cutting device as in claim 3 wherein the four vertical sides are held in a substantially 90 degree angle with one another by mating with top and bottom plates and this mating is made rigid through use of a lock pin that inserts though corresponding holes at the top and bottom of the four vertical sides and the four sides of the top and bottom plates.

17. A meat cutting device as in claim 3 wherein the top and bottom plates are substantially identical and possess an evenly spaced array of apertures with said apertures existing on a different plane than the inter-aperture part of said plates and each said aperture is supported via a dimpling in the plate that possesses a substantially conical shape.

18. A meat cutting device as in claim 3 wherein the cutting guide consists of elongated roller pairs and said rollers are held in their vertical position through the use of guide pins inserted into the hollowed out ends of the elongated rollers and the friction between the roller and guide pin is minimized through the use of a Teflon sleeve surrounding the guide pin and an elastic substance mounted to the top of the guide pin.
